(19) United States
(12) Patent Application Publication
(10) Pub. No.: US 2009/0258601 A1
(43) Pub. Date: Oct. 15, 2009

(54) TRANSMISSION METHOD WITH TRANSMISSION POWER CONTROL

(75) Inventor: Yuh-Ren Jauh, TaoYuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/102,100

(22) Filed: Apr. 14, 2008

(51) Int. Cl. H04B 17/00

(52) U.S. Cl. 455/67.13

(57) ABSTRACT

A transmission method is provided, whereby a first wireless device transmits an RF signal to a second wireless device using desired transmission power. First, the RF signal to be transmitted is provided. First parameters of the first wireless device are detected, as well as the second parameters of the second wireless device. Transmission power of the RF signal is then determined based on the first and second parameters, and the RF signal is accordingly amplified and output for transmission. Specifically, the second parameters may comprise an algorithm for decoding, and a number of receivers are in the second wireless device.

### BACKGROUND OF THE INVENTION

1. Field of the Invention

The invention relates to wireless communication, and in particular, to transmission power control for a wireless communication system.

2. Description of the Related Art

Wireless communication involves various issues, and one of the issues to be concerned about is transmission power. FIG. 1 shows relationships between signal quality and transmission power at different transfer data rates. In FIG. 1, the vertical axis denotes an indicator of signal quality, such as Signal to Noise Ratio (SNR), and the horizontal axis denotes transmission power, an indicator of the signal gain. Conventionally, because signal amplification may cause undesirable non-linear effects, transmission power is a trade off for signal quality. Meanwhile, the effective quality requirements for different transfer rates may be different. For example, if the threshold Q_{OP} indicates the least quality for effective operation, and the three curves represent different transfer data rates Rₐ, R_{b} and R_{c} where R_{c}>R_{b}>Rₐ, it is shown that the maximum effective transmission powers for the different transfer rates Rₐ, R_{b} and R_{c} are respectively bounded at Pₐ, P_{b} and P_{c}, where Pₐ>P_{b}>P_{c}. In other words, higher transfer data rate can only be achieved at lower transmission powers, and consequently, the effective transmission distance is also constrained.

Conventionally, transmission power is determined based on parameters on the transmitter side. FIG. 2 is a flowchart of a conventional transmission method. During step 201, the parameters on the transmitter side are detected and determined. The parameters may comprise the modulation type, the code rate and the bit rate related to the signal for transmission. During step 203, transmission power is determined based on the parameters. For example, the modulation type is selected from one of the 64 QAM, 16 QAM, QPSK and BPSK modes, in which the more complicated modulation type is operative at the lower transmission power, and vice versa. The code rate is selected from “½”, “⅔” or “¾” which may affect the fault tolerance range during transmission, whereby higher transmission power may be adaptable for a higher code rate. The bit rate corresponding to the transfer data rate is inverse proportional to transmission power. Upon confirmation of transmission power during step 203, step 205 is then processed to perform the transmission with determined transmission power.

Since the effective transmission distance is directly affected by transmission power, and transmission power is a tradeoff for the transfer rate, assigning an appropriate transmission power is crucial for maintaining transmission quality when trying to extend the effective transmission distance under a high transfer rate.

### BRIEF SUMMARY OF THE INVENTION

An exemplary embodiment of a transmission method is provided, whereby a first wireless device transmits an RF signal to a second wireless device using desired transmission power. First, the RF signal to be transmitted is provided. First parameters of the first wireless device are detected, as well as the second parameters of the second wireless device. Transmission power of the RF signal is then determined based on the first and second parameters, and the RF signal is accordingly amplified and output for transmission. Specifically, the second parameters comprise an algorithm for decoding, and a number of receivers are in the second wireless device.

When determining the second parameters, the second wireless device may autonomously transmit the second parameters to the first wireless device. Alternatively, the second wireless device may transmit the second parameters to the first wireless device in response to a query request issued by the first wireless device.

The algorithm for decoding is the Minimum Mean-Squared Error (MMSE) algorithm or the Maximum Likelihood (ML) algorithm. When determining transmission power, if the second wireless device uses the MMSE algorithm, transmission power is decreased. On the contrary, if the second wireless device uses the ML algorithm, transmission power is increased. Additionally, transmission power is proportional to the number of receivers in the second wireless device.

In a further embodiment, the first parameters comprise the modulation type, the code rate and the bit rate. The modulation type may be one of the 64 QAM, 16 QAM, QPSK and BPSK modes. The code rate may be one of “½”, “⅔” or “¾”. The bit rate may vary from 54 Mbps, 48 Mbps, 36 Mbps, 24 Mbps, 18 MbPs, and 12 Mbps, and transmission power is inverse proportional to the bit rate.

The RF signal in the embodiment can be particularly implemented with the IEEE 802.11 standard such as IEEE 802.11n or the Multi-in-Multi-Out (MIMO) structure. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows relationships between signal quality and transmission power at different transfer rates;

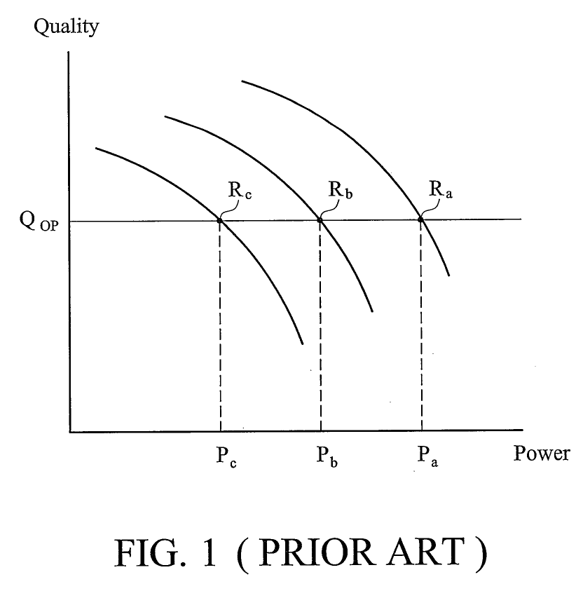

FIG. 2 is a flowchart of a conventional transmission method;

FIG. 3 shows relationships between signal quality and transmission power at different receiver architectures;

FIG. 4 shows relationships between transfer rate versus effective distances;

FIG. 5 shows an embodiment of wireless transmission between first and second wireless devices;

FIG. 6 is a flowchart of a transmission method according to the invention; and

FIG. 7 is a flowchart of transmission power determination according to FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

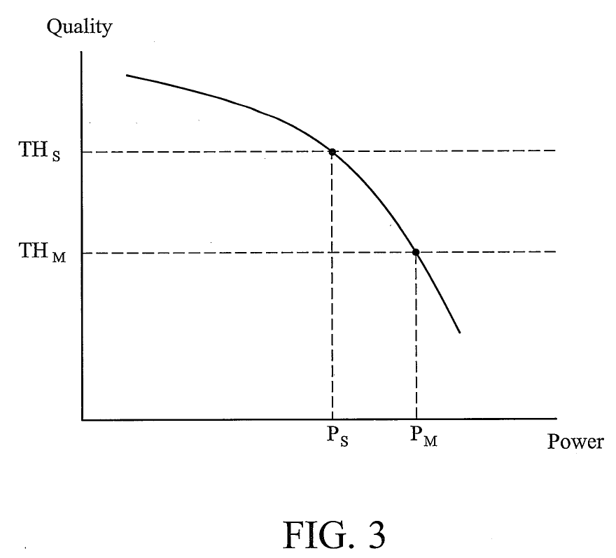

FIG. 3 shows relationships between signal quality and transmission power at different receiver architectures. Different receiver structures may possess different decoding capabilities, therefore acceptable transmission power and quality requirements are varied. For example, the threshold TH_{S} for a single receiver is higher than the threshold TH_{M} for a Multi-In-Multi-Out (MIMO) receiver, which means that when the received signal quality is lower than the threshold TH_{S}, the single receiver may fail to decode the received signal or the signal quality of decoded signal is not acceptable while the MIMO receiver will still operate. From the perspective of transmission power, as shown in the horizontal axis of FIG. 3, the maximum allowable power for the MIMO receiver is P_{M}, which is higher than the maximum allowable power P_{S} of the single receiver. In other words, a multi-receiver structure has better decoding ability to decode signals of higher transmission power.

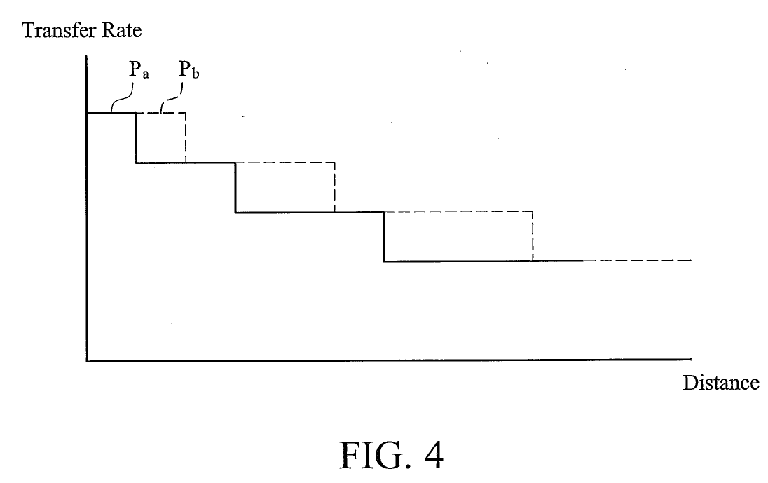

FIG. 4 shows relationships between transfer rates versus effective distances. The real line denotes the operation curve under transmission power Pₐ, and the dashed line denotes a larger transmission power P_{b}. As the transmission distance increases, the transfer rate may stepwise decrease. It is shown that for the same transfer rate, the effective distance for transmission power P_{b} is larger than that of transmission power Pₐ.

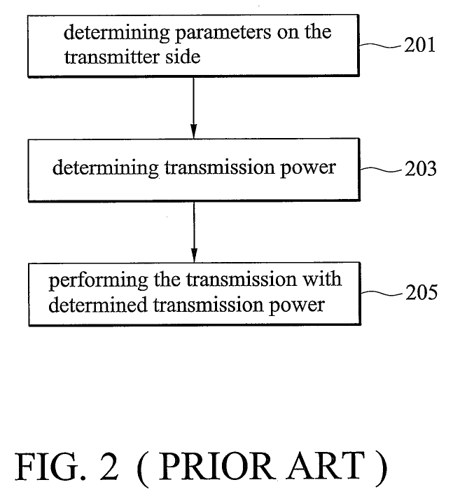

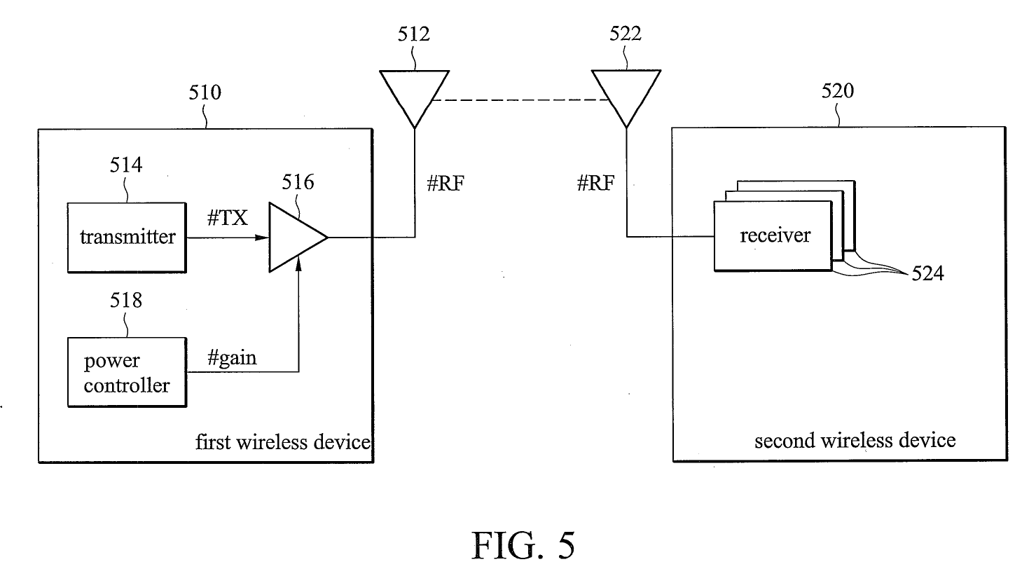

FIG. 5 shows an embodiment of wireless transmission between first and second wireless devices. When the first wireless device 510 is initiated to transmit an RF signal #RF to the second wireless device 520, an outbound signal #TX is first prepared by a transmitter 514. A power controller 518 calculates a gain factor #gain based on various factors, whereby the power amplifier 516 amplifies the outbound signal #TX based on the gain factor #gain to render the RF signal #RE The RF signal #RF is transmitted through an antenna 512, such that the second wireless device 520 receives the RF signal #RF via an antenna 522. Conventionally, the gain factor #gain is solely calculated based on the conditions of the first wireless device 510 employing the transmission method shown in FIG. 2, however, in the embodiment, the conditions in the second wireless device 520 are also considered when determining the gain factor #gain. For example, the second wireless device 520 may be a Multi-receivers structure comprising multiple antennas 522 and receivers 524, such as a Multi-In-Multi-Out (MIMO) structure, and the number of receivers 524 is also a factor to determine the gain factor #gain. Specifically, the gain factor #gain may be corresponding to the number of receivers 524. Table 1 show an example of acceptable transmission power with respect to different number of the receivers 524 and required signal quality Error Vector Magnitude (EVM). It is shown that the acceptable transmission power varies in response to the number of receivers 524. Thus, the power controller 518 calculates the gain factor #gain based on the number of receivers 524. Furthermore, the received RF signal #RF may be decoded by the second wireless device 520 using various algorithms. The algorithm for decoding is also a factor to determine the gain factor #gain. For example, the Minimum Mean-Squared Error (MMSE) algorithm and the Maximum Likelihood (ML) algorithm are most commonly adapted in the second wireless device 520. If the second wireless device 520 uses the MMSE algorithm, the gain factor #gain may be assigned a smaller value, and if the second wireless device 520 uses the ML algorithm, the gain factor #gain can be applied with a larger value because the ML algorithm is more capable of handling lower quality signals in comparison with the MMSE algorithm. Further, the second wireless device 520 may send a request to the first wireless device 510 for designating a desired gain factor. The power controller 518 sets the gain factor #gain as the desired gain factor accordingly. For example, if the second wireless device 520 requires better signal quality, it may send the request for smaller gain factor to the first wireless device 510 so that the first wireless device 510 can transmit the RF signal #RF with smaller gain factor #gain.

TABLE 1

| 1 Receiver 524 | | 3 Receivers 524 | |
|---|---|---|---|
| Required EVM(dB) | Power(dBm) | Required EVM(dB) | Power(dBm) |
| −31 | 13 | −23 | 16 |

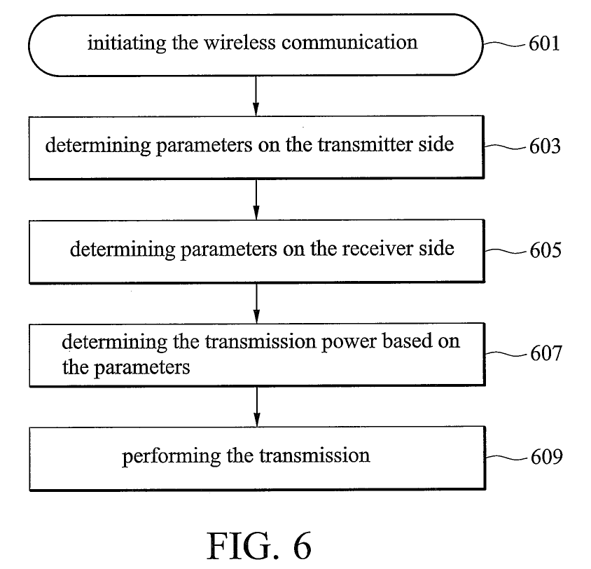

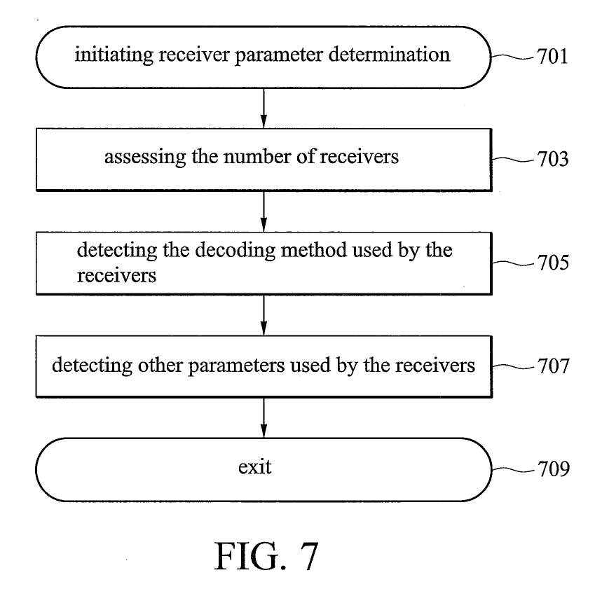

FIG. 6 is a flowchart of a transmission method according to the invention. A transmission method implemented by the first wireless device 510 and second wireless device 520 can be summarized in the following steps. During step 601, the transmission is initiated, and the outbound signal #TX to be amplified is provided. During step 603, parameters in the first wireless device 510 are detected and determined. The step is identical to the prior art, whereby the modulation type, the code rate and the bit rate are considered as factors for determining the gain factor #gain. During step 605, parameters in the second wireless device 520 are also detected and determined. Since the parameters in the second wireless device 520 are currently unknown to the first wireless device 510, a transmission from the second wireless device 520 to the first wireless device 510 is required. The second wireless device 520 may autonomously transmit the parameters to the first wireless device 510. Alternatively, the first wireless device 510 may deliver a query request to the second wireless device 520, and in response, the second wireless device 520 transmits the parameters to the first wireless device 510 when the query request is interpreted and accepted. In the embodiment, the parameters in the second wireless device 520 may include an algorithm for decoding, and a number of receivers 524 are in the second wireless device 520. However the scope of the invention is not limited to the described parameters. Other parameters in the second wireless device 520 may also be considered as factors to determine the gain factor #gain, and detailed description is provided in FIG. 7. During step 607, the gain factor #gain is determined based on the parameters of the first wireless device 510 and second wireless device 520. Each parameter may be weighted by a corresponding weighting factor, and the gain factor #gain may be a value proportional to a linear combination of the weight parameters. Upon confirmation of the gain factor #gain, During step 609, the outbound signal #TX is amplified by the power amplifier 516 based on the gain factor #gain to generate the RF signal #RF, and thereafter, the RF signal #RF is transmitted through the antenna 512.

FIG. 7 is a flowchart of transmission power determination method according to FIG. 6. During step 701, the parameter determination of step 605 is initiated. The second wireless device 520 may comprise of one or more sets of antennas 522 and receivers 524. During step 703, the number of receivers 524 is determined. Generally, if the number of receivers 524 increases, the second wireless device 520 may possess better decoding capability to handle an RF signal #RF of higher transmission power. In other words, transmission power is proportional to the number of receivers 524 in the second wireless device 520. During step 705, the decoding algorithm used by the second wireless device 520 is determined. The algorithm for decoding may be the Minimum Mean-Squared Error (MMSE) algorithm or the Maximum Likelihood (ML) algorithm. Since the tolerance of video quality varies in response to different decoding algorithms, transmission power may be determined, considering decoding algorithms employed in the receivers 524. During step 707, further parameters related to the second wireless device 520 are also considered as factors to determine the gain factor #gain, such as battery status, firmware version, chip version, position and velocity information of the second wireless device 520 estimated through a GPS. For example, if the second wireless device 520 requires better signal quality, it may send the request for smaller gain factor to the first wireless device 510 so that the first wireless device 510 can transmit the RF signal #RF with smaller gain factor #gain. During step 709, all the described parameters are packed and transmitted to the first wireless device 510, whereby the power controller 518 accordingly produces the gain factor #gain, and the power amplifier 516 accordingly generates the #RF signal of desired transmission power.

As a supplemental description, parameters in the first wireless device 510 comprise the modulation type, the code rate and the bit rate. The modulation type is selected from one of the 64 QAM, 16 QAM, QPSK and BPSK modes. The code rate is used for error correction, varying from different combinations such as “½”, “⅔” or “¾”. The bit rate is a dynamically adjustable transfer rate having a certain range dependent on the protocol, such as 54 Mbps, 48 Mbps, 36 Mbps, 24 Mbps, 18 MbPs, and 12 Mbps for 802.11a/b/g standard, and the gain factor #gain is inverse proportional to the bit rate. The embodiment disclosed is particularly adaptable for wireless communication systems conforming to IEEE 802.11 standard or the Multi-in-Multi-Out (MIMO) structure, however, the hardware structure and communication protocol is not limited to the embodiment.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transmission method for a first wireless device to transmit a radio frequency (RF) signal to a second wireless device, comprising:
providing the RF signal to be transmitted;
determining a first parameter of the first wireless device;
determining a second parameter of the second wireless device;
determining transmission power of the RF signal based on the first and second parameter; and
amplifying the RF signal such that the RF signal is delivered at the determined transmission power.

2. The transmission method as claimed in claim 1, wherein determination of the second parameter comprises, the second wireless device transmitting the second parameter to the first wireless device.

3. The transmission method as claimed in claim 1, wherein determination of the second parameter comprises:
the first wireless device delivering a query request to the second wireless device; and
the second wireless device transmitting the second parameter to the first wireless device in response to the query request.

4. The transmission method as claimed in claim 1, wherein the second parameter comprises an algorithm for decoding the RF signal.

5. The transmission method as claimed in claim 4, wherein the algorithm for decoding the RF signal is the Minimum Mean-Squared Error (MMSE) algorithm or the Maximum Likelihood (ML) algorithm.

6. The transmission method as claimed in claim 5, wherein determination of transmission power comprises:
if the second wireless device uses the MMSE algorithm, decreasing the transmission power; and
if the second wireless device uses the ML algorithm, increasing the transmission power.

7. The transmission method as claimed in claim 1, wherein the second parameter comprises a number of receivers in the second wireless device.

8. The transmission method as claimed in claim 7, wherein the transmission power is proportional to the number of receivers in the second wireless device.

9. The transmission method as claimed in claim 1, wherein the first parameter is modulation type, code rate, bit rate or combinations thereof.

10. The transmission method as claimed in claim 1, wherein the RF signal conforms to the IEEE 802.11 standard.

11. A wireless transmitting device, transmitting a radio frequency (RF) signal to a wireless receiving device, comprising:
a transmitter, providing the RF signal to be transmitted;
a power controller, determining a first parameter thereof, and a second parameters of the wireless receiving device, and determining transmission power of the RF signal based on the first and second parameter; and
a gain amplifier, amplifying the RF signal such that the RF signal is delivered at the determined transmission power.

12. The wireless transmitting device as claimed in claim 11, wherein the second parameter is transmitted by the wireless receiving device to the wireless transmitting device.

13. The wireless transmitting device as claimed in claim 11, wherein the wireless transmitting device delivers a query request to the wireless receiving device to obtain the second parameter therefrom.

14. The wireless transmitting device as claimed in claim 11, wherein the second parameter comprises an algorithm for decoding the RF signal.

15. The wireless transmitting device as claimed in claim 14, wherein the algorithm for decoding the RF signal is the Minimum Mean-Squared Error (MMSE) algorithm or the Maximum Likelihood (ML) algorithm.

16. The wireless transmitting device as claimed in claim 15, wherein:
if the wireless receiving device uses the MMSE algorithm, the power controller decreases the transmission power; and
if the wireless receiving device uses the ML algorithm, the power controller increases the transmission power.

17. The wireless transmitting device as claimed in claim 11, wherein the second parameter comprises a number of receivers in the wireless receiving device.

18. The wireless transmitting device as claimed in claim 17, wherein the transmission power is proportional to the number of receivers in the wireless receiving device.

19. The wireless transmitting device as claimed in claim 11, wherein the first parameter is modulation type, code rate, bit rate or combinations thereof.

20. The wireless transmitting device as claimed in claim 11, wherein the RF signal conforms to the IEEE 802.11 standard.
